(19) United States
(12) Patent Application Publication
(10) Pub. No.: US 2004/0112826 A1
(43) Pub. Date: Jun. 17, 2004

(54) Drinking element

(76) Inventors: Akira Chiba, New South Wales (AU); Razmik Mikaelian, New South Wales (AU)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/149,709

(22) PCT Filed: Dec. 8, 2000
(86) PCT No.: PCT/AU00/01519

(51) Int. Cl. B01D 35/02

(52) U.S. Cl. 210/454; 210/321.88; 210/321.89; 210/416.1

(57) ABSTRACT

A drinking element (1) for the drinking of a liquid comprises an outlet (3,10) for receipt in the mouth of a drinker of the liquid whereby the element (1) has one or more hollow filtration membranes (5) that are positionable with respect to the liquid and the outlet (3, 10) such that, when the drinker applies a suction force to the outlet (3, 10) liquid passes to the outlet (3, 10) through the one or more membranes (5) where it is filtered.

### FIELD OF THE INVENTION

The present invention relations to a liquid filtration drinking element. Particularly, though not exclusively, the invention relations to the filtration of drinking fluid using a membrane filter, or more particularly a hollow filtration membrane contained within, attached to or part of, for example, a drinking straw.

### BACKGROUND ART

In many areas around the world water carries significant amounts of particulate matter which may present a serious health problem when the water is used as a drinking supply. Many water supplies require treatment to make them drinkable. Common types of disinfectants used today, especially by travellers going to countries which have a water quality that may present a health problem, are chemicals such as chlorine and iodine. The use of chlorine or iodine to disinfect water is time consuming, clearly inadequate in dealing with the new complex microbiological entities that exist in water, and these agents themselves may cause health problems. Harmful organisms such as Giadia and cryptosporidium are difficult to eradicate with conventional water treatment procedures.

Equipment used to treat drinking water includes different types of filter media disposed in a fluid line; for example, activated carbon or zinc and copper. However, an activated carbon filter is not capable of reducing certain bacteria such as e.Coli and pseudomonas. Furthermore, zinc and copper filters cannot substantially eliminate bacteria in unchlorinated water.

U.S. Pat. No. 5,688,588 discloses a drinking straw that includes a filter plug made of a non-woven fibrous structure. However, because of inherent limitations in the construction of a plug filter per se the drinking straw is ineffective in filtering out smaller bacteria. Table 1 of U.S. Pat. No. 5,688,588 confirms this, wherein a log reduction of 2.5 means that around 0.5% of bacteria still passes through the straw, with potentially fatal or severe consequences.

It would be advantageous if at least preferred embodiments of the present invention overcame or substantially ameliorated at least one of the above disadvantages and/or more generally, provided an improved drinking element.

### SUMMARY OF THE PRESENT INVENTION

The present invention provides a drinking element for the drinking of liquid comprising:

a support having an outlet that is suitable for positioning in the mouth of a drinker of the liquid; and

one or more hollow filtration membranes mounted in the support and extending away therefrom for positioning in the liquid, wherein each membrane defines a chamber therewithin, such that, when each membrane is positioned in the liquid and the drinker applies a suction force to the outlet, liquid passes across the membrane and into the chamber and is filtered thereby, and then passes from the chamber to the outlet.

By employing hollow filtration membranes, very fine (e.g. microfiltration) membrane materials can be employed, without a restricting or limiting pressure drop (i.e. the membrane can be made relatively thin). Such fine filtration characteristics cannot be achieved with filter plugs because with reduced pore size the pressure drop becomes too excessive across the plug.

The outlet can be an open end of the or each membrane, but more typically is a separate part.

Preferably the membranes are one or more hollow fibre membranes. Such membranes are highly efficient at filtration and are easily arranged within a conduit (eg. straw). Alternatively, the membranes can be one or more hollow ceramic or metal membranes.

Preferably a plurality of hollow fibre membranes are provided.

Preferably the membranes have a predetermined pore size or sizes for filtering varying sizes of particulate matter in the liquid to be drunk.

Typically the pore size of the filtration membranes is sufficiently small to filter out particles at a micro level (e.g. less than 0.5 μm) and even to an ultra filtration level (e.g. less than 0.05 μm and down to 0.02 μm).

Preferably the one or more membranes each have an open end that is mounted within a head which is positioned within or is part of the support, with the outlet surrounding or located at the head such that filtered liquid flows via the or each open end to the outlet.

In one variation an inlet extends from the support and is either integral therewith or separately mountable to the support. The inlet can be a hollow conduit extending downwardly from the support in use and having an open lower end through which liquid is drawn into the element. In this regard the one or more membranes can be mounted within the conduit to provide a protective sleeve therefor. Alternatively, for ceramic or metal filtration membranes, such membranes may define the inlet or the conduit.

As a further option, a carbon filter (e.g. manufactured from activated carbon) can be arranged at the support such that liquid passing out of the or each membrane passes through the carbon filter. The carbon filter helps remove organics, some of which can pass through very fine pore-size filters. However, organics are generally of less concern than living organisms such as bacteria.

Preferably the open end of the or each hollow fibre membrane is fasteningly supported in the head, and preferably the head is a bung arranged in the support adjacent to the outlet.

Preferably the or each hollow fibre membrane projects freely from the head either in a closed loop with opposite open ends supported in the head, or as a strand having a single open end supported in the head and a closed opposite remote end.

The outlet or support can also be provided with suitable embossments or threading etc to enable the drinking element to be snap, screw or interface fitted into a container, flask, bottle or other vessel that houses a liquid requiring filtering.

Preferably the drinking element is in the form of a straw.

Thus, the present invention also provides a drinking conduit or straw adapted for the filtration of liquids, especially water, such that the liquid after passing through one or more hollow filtration membranes is delivered filtered and purified to a person's mouth.

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIG. 1 is a plan view of a preferred drinking straw in accordance with the present invention;

FIG. 2 is a cross-sectional size view of the drinking straw shown in FIG. 1 taken along line C-C;

FIG. 3 is a schematic cross-sectional side view of a hollow fibre filtration element for use in a straw in accordance with the present invention;

FIG. 4 is a cross-sectional plan view taken along line D-D in FIG. 2;

FIG. 5 is a plan view of an alternative drinking straw in accordance with the present invention;

FIG. 6 is a cross-sectional side view of the drinking straw of FIG. 5 showing a mouthpiece fitted to the end of the straw;

FIG. 7 is a cross-sectional side view of a further alternative drinking straw in accordance with the present invention with a mouthpiece fitted to the end of the straw;

FIG. 8 is a schematic cross-sectional side view, similar to FIG. 3, but of an alternative hollow fibre filtration element for use in a straw in accordance with the present invention; and

FIGS. 9 and 10 are cross-sectional side views of two further alternative drinking straws in accordance with the present invention, when the membrane is a ceramic or metal material.

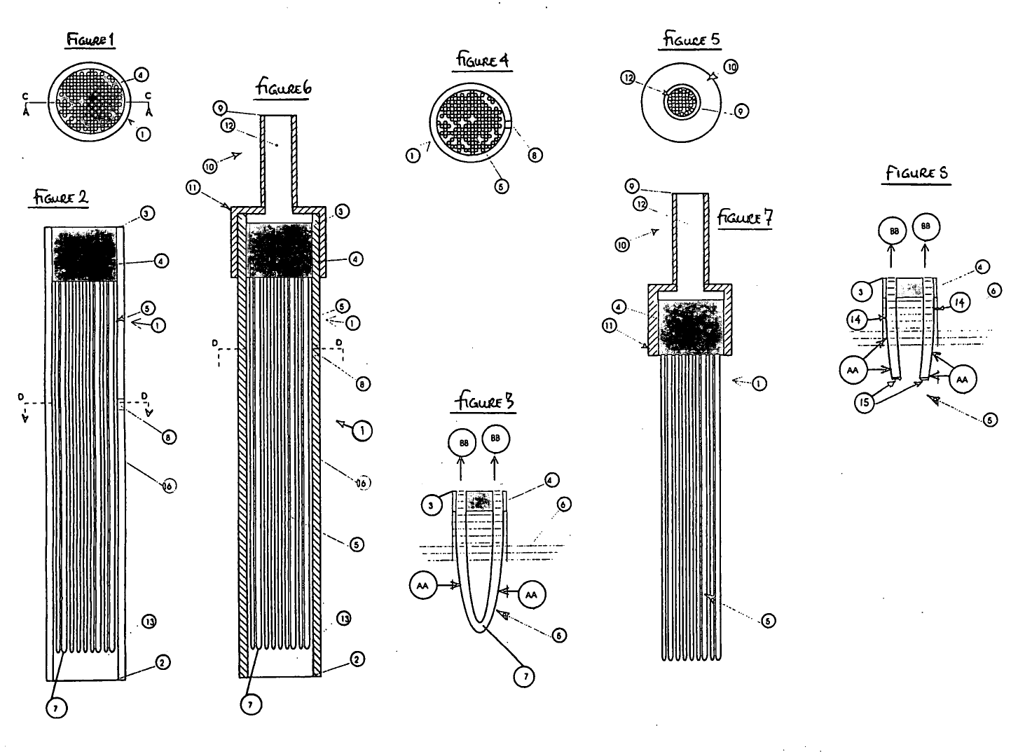

### MODES FOR CARRYING OUT THE INVENTION

Referring to the drawings, in FIGS. 1 and 2 a drinking straw 1 comprises a tube 16 having an open suction end 2 and an opposing mouth end 3, with a passageway 13 therebetween. A sealing head in the form of a bung 4 is positioned in passageway 13 to close mouth end 3, and a filtration element 5 extends therefrom. The element 5 is a filter made of a plurality of hollow fibre membranes 7, disposed within the tube 16, typically such that the two open ends of each fibre strand 7 are incorporated and supported in the bung 4.

Referring now to FIGS. 3 and 8, it can be seen schematically how liquid travels across and into each fibre 7 as indicated by arrows AA and is delivered to a drinker's mouth at the open end(s) of each fibre at end 3 of the straw. Thus, suction or negative pressure is created in the straw 1 by a drinker's back-suction (indicated by arrows BB) and this causes the liquid to pass across the membrane wall and into an interior (chamber) thereof and then out of the open end(s) to a user's mouth. The individual fibres 7 are typically formed of polyethylene, polypropylene or the like (as described below). Also, in FIG. 8, instead of a plurality of loops of hollow fibre membrane, a plurality of individual strands 14 are provided, each having a closed (sealed) end 15.

In use, the fibres 7, 14 are partly or wholly submerged within a liquid 6 requiring filtration such that when a suction force is applied to the straw, the liquid passes through the pores of the fibre 5 leaving some (typically most) or preferably all of the solids, impurities, organisms, organics, etc. in or on the pores of the fibre.

As appropriate, bung 4 can support or be defined by a porous carbon filter (typically employing activated carbon) to filter out any organics and the like in the liquid.

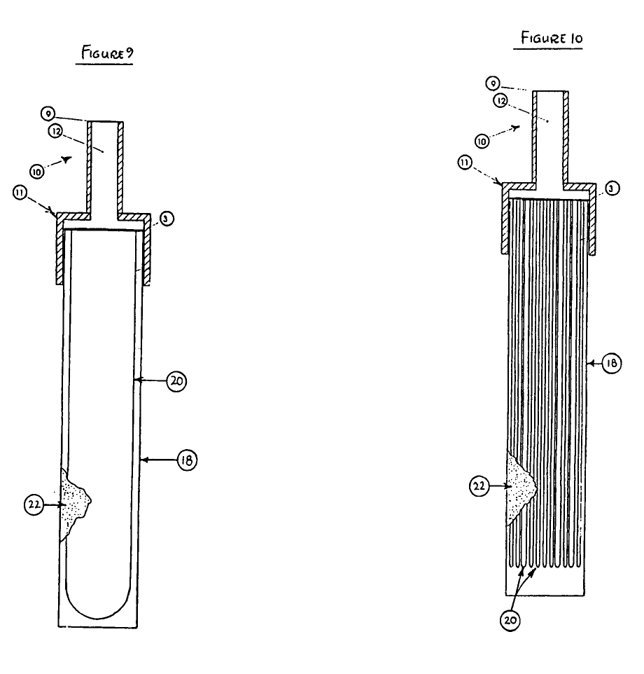

Referring now to FIGS. 5 and 6, where like reference numerals are used to denote similar or like parts, the drinking straw 1 may include a mouthpiece 10 having a protrusion 9 shaped such that it fits comfortably in a user's mouth. The mouthpiece includes a passageway 12 therethrough. An opposing skirt 11 is shaped such that it fits over the end 3 of the tube 16 but so as not to block the open ends of the fibres. The mouthpiece 10 may be permanently attached to the straw 1 or can be removed manually as required, such as by unscrewing (e.g. for use of the straw by different persons). Alternatively, the straw itself may be formed (e.g. moulded) as a single piece to include the shape of the mouthpiece.

The bung 4 is arranged so as to dispose the filter 5 in a selected area of the straw 1, and only permits the passage through the straw of filtered liquid 6 via the pores of the filter 5. Thus, the filtered liquid only exits through the open ends of the membrane and does not otherwise traverse the bung 4.

The tube 16 can also be provided with one or more holes 8 to allow the passage of air out of the straw, to prevent pressure build-up in the interior of the tube 16, created when submersing and then sucking at the drinking straw 1 in the liquid to be filtered.

Referring now to FIG. 7, where like reference numerals denote similar or like parts, the bung 4 is now positioned solely in skirt 11 of mouthpiece 10. In this case, tube 16 is omitted and the filtration element 5 (typically being a filter made of a plurality of hollow fibre membranes) hangs freely in the drinking straw (either as loops 7 or strands 14). However, chambers into which filtered liquid passes are defined on the other side of such membranes.

Rather than (or in addition to) employing hollow fibre membranes, flat filter membranes can be employed (eg. at intervals within tube 16 or at the underside of bung 4, mouthpiece 10 etc), but so as to define a cavity on the other side thereof into which filtered liquid flows before exiting the straw.

The external surface of tube 16 or mouthpiece 10 can be provided with appropriate embossments, protrusions, threading etc which enable the straw to be fitted to an outlet of a container, flask, bottle or other vessel holding a liquid requiring filtering. Such fitting can be snap or interference fitting, screw fitting, friction fitting etc. When the tube or mouthpiece is to be fitted to an externally threaded outlet of a flask, bottle or the like, it can include an integral annular skirt that is internally threaded for mating with the outlet thread. In this case, the tube or mouthpiece would project into the outlet whilst the annular skirt would surround the outlet and mate therewith.

Referring now to FIGS. 9 and 10, where like reference numerals are used to denote similar or like parts, the filter element 5 is now defined to be a solid filtration membrane 18 having one (FIG. 9) or a plurality (FIG. 10) of hollow tubular passageways 20 defined therein and open at their upper end(s). Typically, the membrane 18 is formed from either a ceramic material or a metal material having a plurality of micro-pores 22 defined therein. The tubular passageways define a chamber into which filtered liquid passes, before leaving the element at end 3. The use of mouthpiece 10 is optional but preferred. There is no suction end 2 in the arrangements of FIGS. 9 and 10 as liquid can pass through the membrane over the entire surface thereof.

Many other modifications and alterations are included within the scope of the present invention. For example, the drinking straw may be provided with two sealing means (bungs) placed at each end of the straw.

Also, the drinking straw may be provided with the hollow fibre membranes located partly or wholly outside the tube 16. The suction end can also have one or more passages laterally disposed or protruding from the side wall of the straw (e.g. for simultaneous use by multiple users).

Typically, the hollow fibre membranes are ultra micro-filtration membranes formed from polyethylene (or similar) in a melt spinning and drawing process, such as those produced by Mitsubishi Rayon Co. Ltd. Such membranes have a pore size located between the micro filtration range (0.02 μm-5 μm) and the ultra filtration range (2 nm-0.05 μm) and can filter out fine particles and all bacteria including colloidal silica, bacterial virus, oil emulsions, latex emulsions, cholera bacillus, typhoid bacillus, Escherichia coli, staphylococcus, cryptosporidium, Giardia and Echinococcus granulosus. Typically, such membranes are also treated to be hydrophilic (e.g. covered with a hydrophilic polymer) so as to be wettable in water.

Typically, the ceramic filter is a ceramic element having a microporous structure, such as those manufactured by British Berkefeld or Foseco International. Such filters typically filter particles down to around 0.5 μm in size. Silver metal can also be dispersed throughout the ceramic to prevent the growth of bacteria. Ceramic filter materials include porous clays, ceramic foam filters, silicon carbide and recrystallised silicon carbide materials.

Typically, the metal filter is a sintered metal filter or a laser cut metal filter. These can be in the form of a tube filter defined by a sintered 5-layer plate, metal powder or metal fiber such as those manufactured by Jeongsan Enterprise Inc., or a metal filter cartridge such as those manufactured by Hanyang Engineering Co. Iron cellular filters and aluminium light weight foam filters such as those manufactured by Foseco International may also be employed.

Whilst the invention has been described with reference to a number of preferred embodiments, it should be appreciated that the invention can be embodied in many other forms.

1. A drinking element for the drinking of liquid comprising:
a support having an outlet that is suitable for positioning in the mouth of a drinker of the liquid; and
one or more hollow filtration membranes mounted in the support and extending away therefrom for positioning in the liquid, wherein each membrane defines a chamber therewithin, such that, when each membrane is positioned in the liquid and the drinker applies a suction force to the outlet, liquid passes across the membrane and into the chamber and is filtered thereby, and then passes from the chamber to the outlet.

2. An element as claimed in claim 1, wherein the one or more membranes are one or more hollow fibre membranes, or one or more hollow ceramic or metal membranes.

3. An element as claimed in claim 1 or claim 2, wherein the one or more membranes each have an open end that is mounted within a head which is positioned within or is part of the support, with the outlet surrounding or located at the head such that filtered liquid flows via the or each open end to the outlet.

4. An element as claimed in claim 3, wherein the open end of the or each hollow fiber membrane is fasteningly and permanently supported within the head, the head being a bung arranged in the support adjacent to the outlet.

5. An element as claimed in claim 4, wherein the or each hollow fiber membrane projects freely from the head either in a closed loop with opposite open ends supported in the head, or as a strand having a single open end supported in the head and a closed opposite remote end.

6. An element as claimed in any one of the preceding claims, wherein an inlet extends away from the support in the same direction as the membrane(s), the inlet being either integral with or separately mountable to the support.

7. An element as claimed in claim 6, wherein the inlet is a hollow conduit extending downwardly from the support in use and surrounding the membrane(s), the conduit having an open in-use lower end through which liquid is drawn into the element.

8. An element as claimed in any one of the preceding claims, wherein a carbon filter is arranged at the support, such that liquid passing out of the or each membrane passes through the carbon filter.

9. An element as claimed in any one of the preceding claims that is in the form of a drinking straw.
